(19) United States
(12) Patent Application Publication
(10) Pub. No.: US 2020/0203682 A1
(43) Pub. Date: Jun. 25, 2020

(54) BATTERY PACK, POWER TOOL, AND ELECTRONIC DEVICE

(71) Applicant: MURATA MANUFACTURING CO., LTD., Kyoto (JP)

(72) Inventor: Yoshiyuki BANNAI, Kyoto (JP)

(21) Appl. No.: 16/805,023

(22) Filed: Feb. 28, 2020

Related U.S. Application Data
(63) Continuation of application No. PCT/JP2018/019924, filed on May 24, 2018.

(30) Foreign Application Priority Data
Aug. 30, 2017 (JP) 2017-165047

(51) Int. Cl. H01M 2/10; H01M 10/0525

(52) U.S. Cl. CPC H01M 2/1055; H01M 2220/30; H01M 10/0525

(57) ABSTRACT

A battery pack includes a plurality of secondary batteries, and a battery holding member. The battery holding member is configured to hold the plurality of secondary batteries; and includes a partition part and a thermal expansion material. The partition part is provided between the plurality of secondary batteries to define an arrangement area where the plurality of secondary batteries is disposed.

### CROSS REFERENCE TO RELATED APPLICATIONS

The present application is a continuation of PCT patent application no. PCT/JP2018/019924, filed on May 24, 2018, which claims priority to Japanese patent application no. JP2017-165047 filed on Aug. 30, 2017, the entire contents of which are being incorporated herein by reference.

### BACKGROUND

The present technology generally relates to a battery pack including a plurality of secondary batteries, and a power tool and an electronic device which use the battery pack.

Electronic devices have attained widespread use, and as power supplies applied to the electronic devices, small and lightweight secondary batteries capable of acquiring a high energy density has been developing. The secondary batteries are not only applied to the electronic devices mentioned above, but also applied to other uses such as power tools.

As the electronic devices and the like have higher performance and more functions, there has been demand for increase in energy density of secondary batteries; therefore, the amount of heat generated is increased when the secondary batteries are in use. In view of this, for easy and safe handling of a plurality of secondary batteries, a battery pack accommodating the plurality of secondary batteries in a housing has been used.

### SUMMARY

The present technology generally relates to a battery pack including a plurality of secondary batteries, and a power tool and an electronic device which use the battery pack.

In the conventional technology, the safety of battery packs is still insufficient. Therefore, there is still room for improvement.

The present technology has been achieved in light of such a problem, and therefore, an object of the present technology is to provide a battery pack, a power tool, and an electronic device that are capable of improving safety.

A battery pack according to an embodiment of the present technology includes a plurality of secondary batteries, and a battery holding member. The battery holding member is configured to hold the plurality of secondary batteries. The battery holding member includes a partition part provided between the plurality of secondary batteries to define an arrangement area where the plurality of secondary batteries is disposed; and includes a thermal expansion material.

A power tool and an electronic device according to an embodiment of the present technology each includes a battery pack, and the battery pack has a configuration similar to that of the battery pack according to an embodiment of the present technology.

In the battery pack according to an embodiment of the present technology, the battery holding member includes a partition part for defining an arrangement area where the plurality of secondary batteries are disposed and the battery holding member (partition part) includes a thermal expansion material, which improves the safety. Further, each of the power tool and the electronic device according to an embodiment of the present technology achieves a similar effect.

It should be understood that the effects described herein are not necessarily limited, and any of the effects described in the present technology may be achieved.

### BRIEF DESCRIPTION OF FIGURES

FIG. 1 is a perspective view illustrating a configuration of a battery pack according to an embodiment of the present technology.

FIG. 2 is a perspective view illustrating a configuration of a battery module illustrated in FIG. 1.

FIG. 3 is a cross-sectional view illustrating a configuration of a secondary battery illustrated in FIG. 2.

FIG. 4 is a perspective view for explaining a method of producing a battery pack according to an embodiment of the present disclosure.

FIG. 5 is a cross-sectional view for explaining operation (safe operation) of a battery pack according to an embodiment of the present disclosure.

FIG. 6 is a perspective view illustrating a modification regarding a configuration of a battery pack according to an embodiment of the present disclosure.

FIG. 7 is a perspective view illustrating a configuration of a battery pack according to an embodiment of the present technology.

FIG. 8 is a perspective view illustrating a configuration of a battery holder illustrated in FIG. 7.

FIG. 9 is a cross-sectional view illustrating a modification regarding a configuration of a battery pack according to an embodiment of the present disclosure.

FIG. 10 is a block diagram illustrating a configuration of an application example (power tool) of a battery pack according to an embodiment of the present disclosure.

### DETAILED DESCRIPTION

As described herein, the present disclosure will be described based on examples with reference to the drawings, but the present disclosure is not to be considered limited to the examples, and various numerical values and materials in the examples are considered by way of example

First, a battery pack according to a first embodiment of the present technology is described.

The battery pack described herein is a power supply including a plurality of secondary batteries, and is applied to a variety of applications such as an electronic device.

The type of the electronic device is not particularly limited, and is a laptop personal computer, for example. However, since the application of the battery pack is not limited to the electronic device as mentioned above, the battery pack may be used for other purposes. The application of the battery pack is detailed later.

The type of the secondary battery is not particularly limited, and is a lithium ion secondary battery, for example. However, since the secondary battery is not limited to the lithium ion secondary battery, the secondary battery may be a different secondary battery. The lithium ion secondary battery is detailed later.

First, the overall configuration of the battery pack is described.

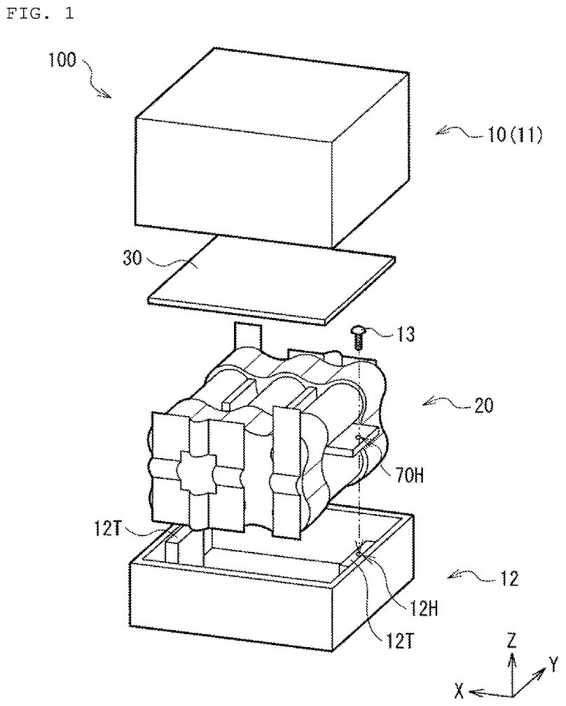

FIG. 1 illustrates a perspective configuration of a battery pack 100 that is an example of the battery pack according to the present embodiment. In this regard, FIG. 1 illustrates a state in which a series of elements (an upper housing 11, a lower housing 12, a battery module 20, and a circuit board 30) of the battery pack 100 are spaced apart from one another.

The battery pack 100 includes, for example, the battery module 20 and the circuit board 30 inside a housing 10, as shown in FIG. 1.

Hereinafter, three axes (an X-axis, a Y-axis, and a Z-axis) illustrated in FIG. 1 are used to define dimensions and directions. Specifically, a dimension in the X-axis direction is regarded as a “width”, a dimension in the Y-axis direction is regarded as a “length”, and a dimension in the Z-axis direction is regarded as a “height”. Further, in the length direction (the Y-axis direction) of FIG. 1, a lower left direction and an upper right direction are regarded as a “front side” and a “rear side”, respectively. In the height direction (the Z-axis direction) of FIG. 1, an upward direction and a downward direction are regarded as an “upper side” and a “lower side”, respectively.

The housing 10 is a box-like housing member that primarily accommodates the battery module 20 and so on. The three-dimensional shape of the housing 10 is not particularly limited, and is a substantially rectangular parallelepiped shape, for example.

In this description, the housing 10 can be divided, for example, in the height direction (the Z-axis direction), in other words, can be divided into upper and lower sections. Specifically, the housing 10 includes the upper housing 11 and the lower housing 12 which are combined together to accommodate the battery module 20 therein.

The lower housing 12 has, for example, two protrusion portions 12T that project inwards. The two protrusion portions 12T are so provided as to be opposed to each other and spaced apart from each other with an interval (a space). This space is a space where the battery module 20 is housed in the lower housing 12.

In the case where the battery module 20 is housed in the lower housing 12, the battery module 20 is disposed between the two protrusion portions 12T and sandwiched between the two protrusion portions 12T. This allows the battery module 20 to be aligned with the lower housing 12 and to be temporarily fixed to the lower housing 12 by using the two protrusion portions 12T when the battery module 20 is housed in the lower housing 12.

In this case, particularly, since the battery module 20 (a plurality of secondary batteries 40 held in a battery holder 50 described later) is spaced apart from the housing 10 through the two protrusion portions 12T, an interval (a gap) is formed between the housing 10 and the battery module 20. This is because, as described later, a margin is left for an abnormal secondary battery 40 that is a heat source to be displaced using a thermal expansion phenomenon of the battery holder 50, which allows the secondary battery 40 to be displaced easily.

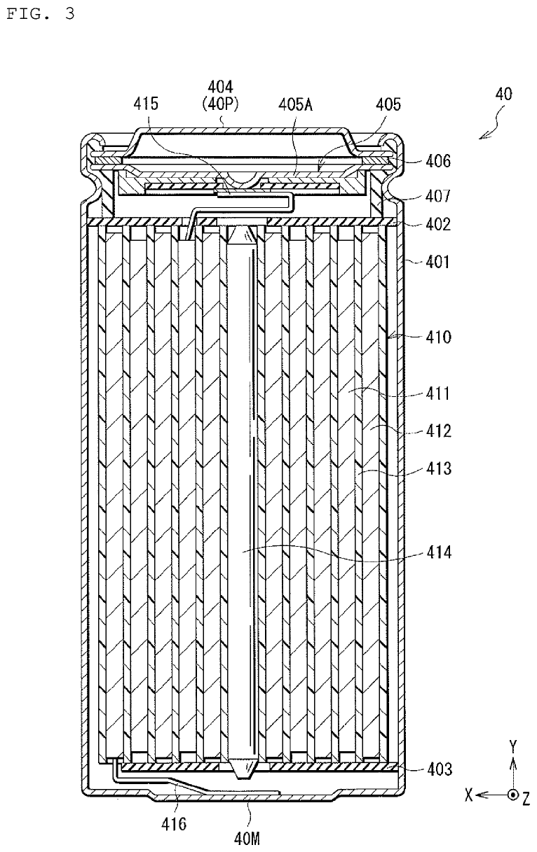

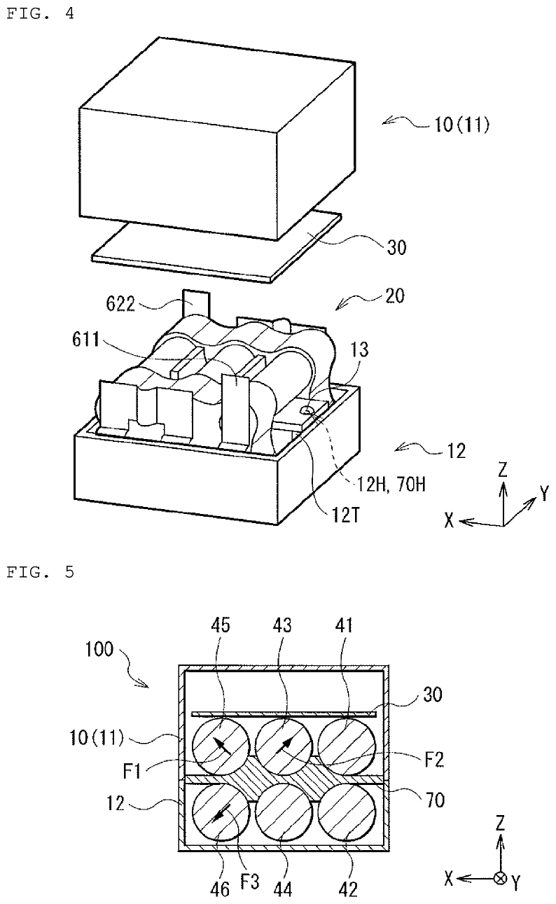

One of the two protrusion portions 12T is provided with, for example, a screw hole 12H extending in the height direction. As described later, for example, a screw 13 is inserted into the screw hole 12H through a partition plate 70 (a through-hole 70H), so that the battery module 20 is screw fixed to the lower housing 12 (see FIG. 4). This makes the battery module 20 connected and fixed to the lower housing 12. The gap between the housing 10 and the battery module 20 is easy to be maintained, and the plurality of secondary batteries 40 is easy to be displaced stably by using the thermal expansion phenomenon of the battery holder 50.

A material for forming the housing 10 is not particularly limited. Specifically, the housing 10 contains, for example, any one of, or two or more of metal materials and polymer materials.

In particular, the housing 10 preferably contains a thermally conductive material with high thermal conductivity. As described later, as with the housing 10, the partition plate 70 contains a thermally conductive material and the partition plate 70 is connected to the lower housing 12, which allows heat generated in the battery module 20 (the abnormal secondary battery 40 that is a heat source) to be easily carried to the lower housing 12; therefore the heat is less likely to be stored in the battery module 20. The thermally conductive material is detailed later.

In this case, particularly, the upper housing 11 and the lower housing 12 are combined with each other and are connected to each other; therefore, heat generated in the battery module 20 is easily carried to the upper housing 11 through the lower housing 12. Thereby, the heat generated in the battery module 20 is easily carried to the entirety of the housing 10 (the upper housing 11 and the lower housing 12); therefore the heat is less likely to be stored in the battery module 20.

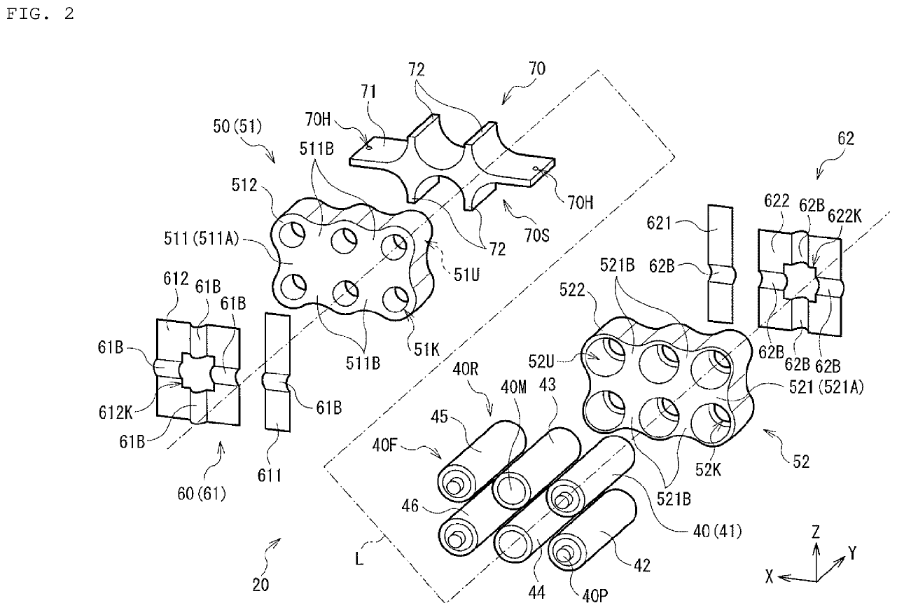

The battery module 20 is primarily a battery element that generates electric power by using the plurality of secondary batteries 40 (see FIG. 2). The detailed configuration of the battery module 20 is described later (see FIG. 2).

The circuit board 30 is primarily a board for controlling operation of the entirety of the battery pack 100 and is a mounting board on which a plurality of so-called electronic components is mounted.

The circuit board 30 is disposed, for example, between the upper housing 11 and the battery module 20, and is connected to a connection terminal plate 60 (terminal plates 611 and 621), described later, of the battery module 20.

Subsequently, the configuration of the battery module 20 is described.

FIG. 2 illustrates a perspective configuration of the battery module 20 of FIG. 1. In this regard, FIG. 2 illustrates, for example, a state in which a series of elements (the plurality of secondary batteries 40, the battery holder 50, the connection terminal plate 60, and the partition plate 70) of the battery module 20 are spaced apart from one another.

The battery module 20 includes, for example, the plurality of secondary batteries 40, the battery holder 50, the connection terminal plate 60, and the partition plate 70 as shown in FIG. 2.

The secondary battery 40 is a main part of the battery pack 100, and is a so-called power supply. In this description, the secondary battery 40 is, for example, a so-called cylindrical lithium ion secondary battery, and extends in the length direction (the Y-axis direction).

The secondary battery 40 includes, for example, a protruding positive electrode terminal part 40P that is provided in one end of the secondary battery 40 in the length direction and a non-protruding negative electrode terminal part 40M that is provided in the other end of the secondary battery 40 in the length direction.

Further, the secondary battery 40 has, for example, a front part 40F that is a first end on the front side and a rear part 40R that is a second end on the rear side.

The front part 40F is a part that is held in a front battery holder 51, described later, of the battery holder 50, and the rear part 40R is a part that is held in a rear battery holder 52, described later, of the battery holder 50.

The number of secondary batteries 40 is not particularly limited. In this case, the battery module 20 includes, for example, the six secondary batteries 40 (41 to 46). The secondary batteries 41 to 46 are arranged in, for example, three columns in the width direction (the X-axis direction) and two levels in the height direction. For easy understanding of the positional relationship of the series of elements of the battery module 20, a line L of FIG. 2 is an imaginary line in the direction toward which the secondary battery 41 extends.

The orientation of each of the secondary batteries 41 to 46 is not particularly limited, provided that the secondary batteries 41 to 46 are connected to one another. In this case, in order that the secondary batteries 41 to 46 are connected to one another in the form of two in parallel and three in series, the positive electrode terminal part 40P of each of the secondary batteries 41, 42, 45, and 46 faces forward, and the negative electrode terminal part 40M of each of the secondary batteries 43 and 44 faces forward.

The detailed configuration of the secondary battery 40 (the cylindrical lithium ion secondary battery) is described later (see FIG. 3).

The battery holder 50 is primarily a battery holding member for holding the plurality of secondary batteries 40. In this description, the battery module 20 has the two battery holders 50, for example. To be specific, the battery holder 50 has, for example, the front battery holder 51 that is a first battery holding member and the rear battery holder 52 that is a secondary battery holding member.

The front battery holder 51 is disposed on the front side of the plurality of secondary batteries 40, and has a plurality of recesses 51U in which to hold the plurality of secondary batteries 40, for example. The recess 51U has, on the bottom, cavities 51K for example, the cavities 51K connecting the plurality of secondary batteries 40 and the connection terminal plate 60 (a front connection terminal plate 61) to each other.

The three-dimensional shape of the recess 51U is not particularly limited, and is, for example, a cylindrical shape corresponding to the three-dimensional shape (cylindrical shape) of the secondary battery 40. The opening shape of the cavity 51K is not particularly limited, and is, for example, a circular shape. Note that the diameter of the cavity 51K is, for example, smaller than the outer diameter of the secondary battery 40 in order to prevent the secondary battery 40 from falling from the cavity 51K.

The front battery holder 51 includes a partition part 511 to form the plurality of recesses 51U. The partition part 511 is disposed among the plurality of secondary batteries 40 to define an arrangement area where the plurality of secondary batteries 40 is disposed.

Specifically, the front battery holder 51 includes, for example, the partition part 511 and a frame part 512 connected to the partition part 511.

As described above, in order to define the arrangement area of the plurality of secondary batteries 40, the partition part 511 includes a support plate part 511A and a plurality of partition parts 511B. The support plate part 511A extends in the width direction. The plurality of partition parts 511B extends in the length direction, and is provided in each of the upper surface and the lower surface of the support plate part 511A so as to be spaced apart from one another with an interval.

The frame part 512 is an outer frame disposed around the plurality of secondary batteries 40, and is a member for supporting the partition part 511. The frame part 512 is, for example, connected to the partition part 511 and is thereby integral with the partition part 511.

The front battery holder 51 includes the partition part 511, which allows the plurality of secondary batteries 40 to be provided in a state spaced apart from one another with an interval. Further, since the front battery holder 51 includes the frame part 512 as well as the partition part 511, as described above, the plurality of secondary batteries 40 is held in the front battery holder 51 in a state where the plurality of secondary batteries 40 is spaced apart from one another with an interval.

In this case, the front battery holder 51 includes, for example, the six recesses 51U and the six cavities 51K corresponding to the six secondary batteries 40 (41 to 46). In relation to this, the partition part 511 includes, for example, one support plate part 511A, two partition parts 511B provided on the upper surface of the support plate part 511A, and two partition parts 511B provided on the lower surface of the support plate part 511A. An arrangement pattern of the six recesses 51U correspond to, for example, the arrangement pattern of the six secondary batteries 41 to 46 (three columns in the width direction and two levels in the height direction).

The front parts 40F of the individual secondary batteries 41 to 46 are inserted into the six recesses 51U of the front battery holder 51, which allows the front battery holder 51 to hold the secondary batteries 41 to 46.

The rear battery holder 52 is disposed on the rear side of the plurality of secondary batteries 40, and has a configuration similar to that of the front battery holder 51, except that the rear battery holder 52 holds the rear part 40R of each of the plurality of secondary batteries 40.

Specifically, the rear battery holder 52 has, for example, a plurality of recesses 52U in which to hold the plurality of secondary batteries 40. The recess 52U has, on the bottom, cavities 52K for example, the cavities 52K connecting the plurality of secondary batteries 40 and the connection terminal plate 60 (a rear connection terminal plate 62) to each other. The details of the recesses 52U and the cavities 52K are similar, for example, to those of the recesses 51U and the cavities 52K.

The rear battery holder 52 includes, for example, a partition part 521 and a frame part 522 to form the plurality of recesses 52U, and the partition part 521 includes, for example, a support plate part 521A and a plurality of partition parts 521B. The details of each of the partition part 521 (the support plate part 521A and the partition part 521B) and the frame part 522 are, for example, similar to the details of each of the partition part 511 (the support plate part 511A and the partition part 511B) and the frame part 512.

The rear battery holder 52 includes the partition part 521, which allows the plurality of secondary batteries 40 to be provided in a state spaced apart from one another with an interval. Further, since the rear battery holder 52 includes the frame part 522 as well as the partition part 521, as described above, the plurality of secondary batteries 40 is held in the rear battery holder 52 in a state where the plurality of secondary batteries 40 is spaced apart from one another with an interval.

In this case, the rear battery holder 52 includes, for example, the six recesses 52U and the six cavities 52K corresponding to the six secondary batteries 40 (41 to 46), and also includes one support plate part 521A and four partition parts 521B. An arrangement pattern of the six recesses 52U is similar to, for example, the arrangement pattern of the six recesses 51U.

The rear parts 40F of the individual secondary batteries 41 to 46 are inserted into the six recesses 52U of the rear battery holder 52, which allows the rear battery holder 52 to hold the secondary batteries 41 to 46.

The battery module 20 includes the two battery holders 50 (the front battery holder 51 and the rear battery holder 52). This is because the plurality of secondary batteries 40 is easy to be held stably as compared with a case where the battery module 20 includes only one battery holder 50.

The battery holder 50 (the front battery holder 51 and the rear battery holder 52) contains any one of, or two or more of thermal expansion materials. The “thermal expansion material” is a general term for materials capable of expanding thermally by using heat excessively generated by the secondary battery 40 due to some factor. The cause of the heat generation in the secondary battery 40 is, for example, a short circuit.

The physical properties of the thermal expansion material are not particularly limited as long as the thermal expansion material is capable of expanding thermally by using heat. The thermal expansion ratio of the thermal expansion material is not particularly limited; however it is preferable that a thermal expansion ratio of the thermal expansion material is as high as possible. Specifically, the thermal expansion ratio is preferably 5 times or more. This is because the battery holder 50 is easy to sufficiently expand thermally when the secondary battery 40 generates heat. The “thermal expansion ratio” described herein is a thermal expansion ratio for the case where heat is applied to reach a temperature of approximately 150° C. to 300° C. The upper limit value of the thermal expansion ratio is not particularly limited; however, the thermal expansion ratio is preferably equal to or lower than 30 times.

The types of the thermal expansion materials are not particularly limited, provided that the materials correspond to any one of, or two or more of materials having the foregoing physical properties. Specifically, the thermal expansion material is, for example, thermal expansion rubber and thermal expansion sponge. More specifically, the thermal expansion rubber is, for example, thermal expansion fire-resistant material Fi-Block (registered trademark) made by SEKISUI CHEMICAL CO., LTD., and thermal expansion heat insulation rubber made by Fujikura Rubber Ltd. The thermal expansion sponge is, for example, thermal expansion fire-resistant sponge made by CRK Corporation.

In particular, in the case where the thermal expansion material is an elastic material such as the thermal expansion rubber and the thermal expansion sponge, the thermal expansion material absorbs vibration and so on, leading to improvement in impact resistance of the battery module 20.

The reason why the battery holder 50 includes the thermal expansion material is that, in a state where the plurality of secondary batteries 40 is held in the battery holder 50, when some of the secondary batteries 40 generate heat excessively, the battery holder 50 expands thermally in response to the heat generation. Specifically, a section of the battery holder 50, primarily, a section near the part of the secondary batteries 40 generating heat excessively preferentially expands thermally.

In such a case, a part of the battery holder 50, near the part of the secondary batteries 40 that is the heat source, partially expands thermally, which causes the battery holder 50 to thermally deform to distance the part of the secondary batteries 40 from the other secondary batteries 40. Thereby, the abnormal part of the secondary batteries 40 are displaced away from the other normal secondary batteries 40, so that the heat generated in the part of the secondary batteries 40 is less likely to be carried to the other secondary batteries 40. Thus, the heat is less likely to be stored in the entirety of the battery module 20, and the plurality of secondary batteries 40 is less likely to catch fire.

The “catching fire” is a phenomenon in which the heat generated in the abnormal secondary batteries 40 that is the heat source is excessively carried to the other normal secondary batteries 40, and consequently, the normal secondary batteries 40 fire secondarily due to the firing of the abnormal secondary batteries 40, resulting in continuous and accelerated firing (combustion) of the plurality of secondary batteries 40 as a whole.

The connection terminal plate 60 is primarily a connection terminal member for electrically connecting the plurality of secondary batteries 40 to one another. In this case, the battery module 20 includes, for example, the two connection terminal plates 60 (the front connection terminal plate 61 and the rear connection terminal plate 62).

The front connection terminal plate 61 is disposed on the front side of the front battery holder 51 and is electrically connected to two or more of the plurality of secondary batteries 40. In relation to this, the front connection terminal plate 61 has, for example, the terminal plates 611 and 612 separated from each other.

The terminal plate 611 is, for example, electrically connected to the two secondary batteries 40 (41 and 42). Specifically, the terminal plate 611 is, for example, electrically connected to the positive electrode terminal part 40P of each of the secondary batteries 41 and 42. In relation to this, the terminal plate 611, for example, extends from a position corresponding to the positive electrode terminal part 40P of the secondary battery 41 to a position corresponding to the positive electrode terminal part 40P of the secondary battery 42. In other words, the terminal plate 611 has a strip-like three-dimensional shape extending in the height direction.

The terminal plate 611 is, for example, stretchable in accordance with displacement of the two secondary batteries 41 and 42 electrically connected to the terminal plate 611. This is because the electrical connection between the secondary battery 40 and the terminal plate 611 is easy to be maintained even if the secondary battery 40 is displaced by using the thermal expansion phenomenon of the battery holder 50.

Specifically, the terminal plate 611 has a bent portion 61B which allows the terminal plate 611 to be stably stretchable in accordance with displacement of the two secondary batteries 41 and 42. The bent portion 61B is, for example, a portion bent in such a manner that a part of the terminal plate 611 is away from the two secondary batteries 41 and 42. To be specific, the bent portion 61B primarily functions as a margin which allows the terminal plate 611 to elongate and shorten in the height direction, in other words, functions as a margin which allows the dimension of the terminal plate 611 to be changed in the height direction. The terminal plate 611 is thereby stretchable in the height direction by using the bent portion 61B. Note that, for example, the bent portion 61B may curve or may be bent once or twice or more in a middle thereof. FIG. 2 illustrates, for example, a case where the bent portion 61B curves.

The number of bent portions 61B provided in the terminal plate 611 is not particularly limited, and may be only 1, or 2 or more. FIG. 2 illustrates, for example, a case where one bent portion 61B is provided in the terminal plate 611.

The position at which the bent portion 61B is provided in the terminal plate 611 is not particularly limited. In particular, the bent portion 61B is preferably provided in a position that does not overlap the two secondary batteries 41 and 42. This is because the electrical connection between the terminal plate 611 and the two secondary batteries 41 and 42 is secured and the terminal plate 611 is easy to stretch using the bent portion 61B.

The terminal plate 612 is, for example, electrically connected to the four secondary batteries 40 (43 to 46). Specifically, the terminal plate 612 is, for example, electrically connected to the negative electrode terminal part 40M of each of the secondary batteries 43 and 44 and the positive electrode terminal part 40P of each of the secondary batteries 45 and 46. In relation to this, the terminal plate 612, for example, extends from a position corresponding to the negative electrode terminal part 40M of the secondary battery 43 to a position corresponding to the positive electrode terminal part 40P of the secondary battery 45 via positions corresponding to the negative electrode terminal part 40M of the secondary battery 44 and the positive electrode terminal part 40P of the secondary battery 46. In other words, the terminal plate 612 has, for example, a ring-like three-dimensional shape having an opening 612K.

The terminal plate 612 is, for example, stretchable in accordance with displacement of the four secondary batteries 43 to 46 electrically connected to the terminal plate 612. This is because the electrical connection between the secondary battery 40 and the terminal plate 612 is easy to be maintained even if the secondary battery 40 is displaced by using the thermal expansion phenomenon of the battery holder 50.

Specifically, the terminal plate 612 has the bent portion 61B which allows the terminal plate 612 to be stably stretchable in accordance with displacement of the four secondary batteries 43 to 46. The details of the bent portion 61B are described above.

FIG. 2 illustrates, for example, a case where the terminal plate 612 is provided with the four bent portions 61B. Specifically, the bent portion 61B is provided in each part of a couple extending in the width direction of the terminal plate 612, and in each part of a couple extending in the height direction of the terminal plate 612. The bent portions 61B primarily function as a margin which allows the dimension of the terminal plate 612 to be increased and reduced in the width direction and in the height direction; therefore, the terminal plate 612 is stretchable in the width direction and in the height direction by using the bent portions 61B.

The position at which the bent portions 61B are provided in the terminal plate 612 is not particularly limited. In particular, the bent portions 61B are preferably provided in a position that does not overlap the four secondary batteries 43 to 46. This is because the electrical connection between the terminal plate 612 and the four secondary batteries 43 to 46 is secured and the terminal plate 612 is easy to stretch using the bent portions 61B.

The rear connection terminal plate 62 has a configuration similar to that of the front connection terminal plate 61 described above, except that the rear connection terminal plate 62 is disposed on the rear side of the rear battery holder 52.

Specifically, the rear connection terminal plate 62 has, for example, the terminal plates 621 and 622 separated from each other.

The terminal plate 621 has a configuration similar to that of the terminal plate 611 described above, except that the terminal plate 621 is, for example, electrically connected to the two secondary batteries 40 (45 and 46). Specifically, the terminal plate 621 is, for example, electrically connected to the negative electrode terminal part 40M of each of the secondary batteries 45 and 46. Further, the terminal plate 621 has, for example, one bent portion 62B, and is stretchable in the height direction in accordance with displacement of the two secondary batteries 45 and 46 electrically connected to the terminal plate 621. The details of the bent portion 62B are, for example, similar to those of the bent portion 61B described above.

The terminal plate 622 has a configuration similar to that of the terminal plate 612 described above, except that the terminal plate 622 is, for example, electrically connected to the four secondary batteries 40 (41 to 44). Specifically, the terminal plate 622 is, for example, electrically connected to the negative electrode terminal part 40M of each of the secondary batteries 41 and 42 and to the positive electrode terminal part 40P of each of the secondary batteries 43 and 44. Further, the terminal plate 622 has, for example, the four bent portions 62B, and is stretchable in the width direction and in the height direction in accordance with displacement of the four secondary batteries 41 to 44 electrically connected to the terminal plate 622.

The partition plate 70 is disposed between the front battery holder 51 and the rear battery holder 52. The partition plate 70 is a partition member that is disposed among the plurality of secondary batteries 40 to primarily define an arrangement area where the plurality of secondary batteries 40 is disposed.

The partition plate 70 has, for example, a plurality of arrangement spaces 70S.

The arrangement space 70S is a space where the secondary battery 40 is disposed. The secondary battery 40 is disposed in the arrangement space 70S, so that the secondary battery 40 is supported on the partition plate 70.

The partition plate 70 has, for example, a configuration similar to that of the partition parts 511 and 521 of the battery holder 50. Specifically, the partition plate 70 includes, for example, a support plate part 71 extending in the width direction and a plurality of partition parts 72 that is provided in the support plate part 71 to extend in the length direction.

In this case, the partition plate 70 includes, for example, six arrangement spaces 70S corresponding to the six secondary batteries 40 (41 to 46). In relation to this, the partition plate 70 includes, for example, one support plate part 71, two partition parts 72 provided on the upper surface of the support plate part 71, and two partition parts 72 provided on the lower surface of the support plate part 71. An arrangement pattern of the six arrangement spaces 70S correspond to, for example, the arrangement pattern of the six secondary batteries 41 to 46.

As described above, the through-hole 70H extending in the height direction is provided, for example, in one end and the other end of the support plate part 71 in the width direction.

In other words, the support plate part 71 has, for example, the two through-holes 70H. This is because, in whichever direction the partition plate 70 faces along the width direction, the partition plate 70 can be fixed to the lower housing 12 with the screw 13.

A material for forming the partition plate 70 is not particularly limited. Specifically, the partition plate 70 contains, for example, any one of, or two or more of metal materials, polymer materials, and advanced ceramics.

In particular, the partition plate 70 preferably contains a material (a thermal expansion material) similar to that for forming the battery holder 50. Since the secondary battery 40 that is the heat source is displaced not only using the thermal expansion phenomenon of the battery holder 50 but also using the thermal expansion phenomenon of the partition plate 70, the plurality of secondary batteries 40 is less likely to catch fire.

Further, the partition plate 70 preferably contains a thermally conductive material with high thermal conductivity. This is because, even if the secondary battery 40 supported on the partition plate 70 generates heat, the heat is easy to be carried from the secondary battery 40 to the partition plate 70; therefore the heat is less likely to be stored in the entirety of the battery module 20. In other words, even if some of the secondary batteries 40 generate heat, the heat is carried through the partition plate 70 to the other secondary batteries 40. Thereby, the heat generated in some of the secondary batteries 40 is dispersed in the plurality of secondary batteries 40, which prevents variation in temperature of the individual secondary batteries 40.

In this case, particularly, the housing 10 (the upper housing 11 and the lower housing 12) contains a thermally conductive material, and the partition plate 70 is connected to the housing 10 as described above. Thereby, the heat generated in the abnormal secondary battery 40 as the heat source is easy to be carried through the partition plate 70 to the housing 10. Therefore, the heat is less likely to be stored in the entire battery module 20.

The “thermally conductive material” is a general term for materials capable of carrying heat smoothly and stably. The physical properties of the thermally conductive material are not particularly limited as long as the thermally conductive material has physical properties of carrying heat smoothly and stably; however, it is preferably as high as possible. Specifically, the thermal conductivity of the thermally conductive material is preferably 0.5 W/(m·K) or higher. This is because, at the time of heat generation of the secondary battery 40, the partition plate 70 is easy to carry the heat sufficiently.

The types of the thermally conductive materials are not particularly limited, provided that the materials correspond to any one of, or two or more of materials having the foregoing physical properties. Specifically, examples of the thermally conductive material include highly-thermally-conductive resin, highly-thermally-conductive rubber, metal material, and advanced ceramics. The highly-thermally-conductive resin is, for example, thermal conductive polycarbonate (insulation type) TPN2354 made by Mitsubishi Engineering-Plastics Corporation, and so on. The highly-thermally-conductive rubber is, for example, silicone rubber with alumina (aluminum oxide) kneaded, and so on. The metal material is, for example, aluminum of which a surface has been subjected to a sufficient insulation treatment. The advanced ceramics is, for example, alumina, aluminum nitride, and so on.

It is of course possible that the partition plate 70 contains a material having thermally expansion property and thermal conductivity. In this case, even if the secondary battery 40 generates heat excessively, the heat is less likely to be stored in the entirety of the battery module 20, so that the plurality of secondary batteries 40 is less likely to catch fire.

Subsequently, the configuration of the secondary battery 40 is described.

FIG. 3 illustrates the configuration of the cross-section of the secondary battery 40 illustrated in FIG. 2. The secondary battery described herein is, for example, a cylindrical lithium ion secondary battery as mentioned above. In the lithium ion secondary battery, lithium is used as an electrode reactant, and a capacitance of a negative electrode 412 is obtained by using an occlusion phenomenon of lithium and a release phenomenon of lithium.

Specifically, as illustrated in FIG. 3, the secondary battery 40 includes, for example, a pair of insulating plates 402 and 403 and a wound electrode body 410 inside a battery can 401. The wound electrode body 410 is, for example, a wound body in which a positive electrode 411 and the negative electrode 412 are stacked with a separator 413 interposed therebetween and a positive electrode 411, the negative electrode 412, and the separator 413 are wound. The wound electrode body 410 includes, for example, an electrolytic solution that is a liquid electrolyte.

The battery can 401 has, for example, a hollow and cylindrical shape with one end closed and the other end open, and contains, for example, any one of, or two or more of iron, aluminum, and alloys thereof. The pair of insulating plates 402 and 403 is disposed, for example, to extend perpendicularly to the wound circumferential surface of the wound electrode body 410 and to sandwich the wound electrode body 410.

A battery cover 404, a safety valve mechanism 405, and a Positive Temperature Coefficient (PTC) element 406 that is a thermosensitive resistive element are crimped to an opening end of the battery can 401 using a gasket 407. The battery can 401 is thereby sealed. The battery cover 404 contains, for example, a material similar to that of the battery can 401, and functions as the positive electrode terminal part 40P described above. Each of the safety valve mechanism 405 and the PTC element 406 is provided inside the battery cover 404, and the safety valve mechanism 405 is electrically connected to the battery cover 404 through the PTC element 406. In the safety valve mechanism 405, since a disk plate 405A is inverted when an internal pressure reaches a predetermined level or more due to internal short circuiting, external heating, and so on, the battery cover 404 and the wound electrode body 410 are electrically disconnected from each other. The resistance of the PTC element 406 increases as the temperature rises, in order to prevent abnormal heat generation due to a large current. The gasket 407 includes, for example, an insulating material.

A center pin 414 is inserted into a space provided at the center of winding of the wound electrode body 410, for example. The secondary battery 40 is, however, not necessarily provided with the center pin 414. A positive electrode lead 415 is attached to the positive electrode 411, and the positive electrode lead 415 contains, for example, any one of, or two or more of conductive materials such as aluminum. A negative electrode lead 416 is attached to the negative electrode 412, and the negative electrode lead 416 contains, for example, any one of, or two or more of conductive materials such as nickel. Since the negative electrode lead 416 is electrically connected to the battery can 401, the battery can 401 functions as the negative electrode terminal part 40M.

The positive electrode 411 includes, for example, a positive electrode current collector and a positive electrode active material layer provided on one side or both sides of the positive electrode current collector.

The positive electrode current collector includes, for example, any one of, or two or more of conductive materials such as aluminum. The positive electrode active material layer includes, for example, a positive electrode active material capable of occluding and releasing lithium, a positive electrode binder, and a positive electrode conductive agent.

The positive electrode active material includes, for example, any one of, or two or more of lithium-containing compounds, and the lithium-containing compound is, for example, a lithium transition metal-containing composite oxide, a lithium transition metal-containing phosphate compound, or the like. The lithium transition metal-containing composite oxide is a composite oxide containing, as constituent elements, lithium, one or two or more transition metal elements, and so on, and the lithium transition metal-containing phosphate compound is a phosphate compound containing, as constituent elements, lithium, one or two or more transition metal elements, and so on. The types of the transition metal elements are not particularly limited and, for example, nickel, cobalt, manganese, or iron.

The positive electrode binder includes any one of, or two or more of synthetic rubbers and polymer materials, for example. The synthetic rubbers are, for example, styrene-butadiene rubbers, fluorine rubbers or ethylene propylene diene.

The polymer materials are, for example, polyvinylidene fluoride or polyimide.

The positive electrode conductive agent includes, for example, any one of, or two or more of carbon materials. The carbon materials are, for example, graphite, carbon black, acetylene black or ketjen black.

The negative electrode 412 includes, for example, a negative electrode current collector and a negative electrode active material layer provided on one side or both sides of the negative electrode current collector.

The negative electrode current collector includes, for example, any one of, or two or more of conductive materials such as copper. The negative electrode active material layer includes, for example, a negative electrode active material capable of occluding and releasing lithium, a negative electrode binder, and a negative electrode conductive agent.

The negative electrode active material includes, for example, any one of, or two or more of carbon materials and metallic materials. Examples of the carbon materials include graphitizable carbon, non-graphitizable carbon, and graphite. The metallic material is a general term for materials including, as constituent elements, any one of, or two or more of metal elements and metalloid elements, for example. The metallic material may be any one of a simple substance, an alloy, a compound, may be two or more thereof, or may be a material including one or two or more phases thereof. The types of the metal elements and the metalloid elements are not particularly limited, and examples of the metal elements and metalloid elements include magnesium, boron, aluminum, gallium, indium, silicon, germanium, tin, lead, bismuth, cadmium, silver, zinc, hafnium, zirconium, yttrium, palladium, and platinum.

The details of the negative electrode binder and the negative electrode conductive agent are, for example, similar to those of the positive electrode binder and the positive electrode conductive agent described above.

In this secondary battery 40, the electrochemical equivalent of the negative electrode active material capable of occluding and releasing lithium is set to be larger than the electrochemical equivalent of the positive electrode 411 in order to prevent lithium metal from being unintentionally deposited on the surface of the negative electrode 412 in the process of charging as described above.

The separator 413 is disposed between the positive electrode 411 and the negative electrode 41, and the separator 413 allows passage of lithium ions while preventing a short circuit due to the current caused by the contact between the positive electrode 411 and the negative electrode 412. The separator 413 contains, for example, any one of, or two or more of porous membranes such as synthetic resins and ceramics. Examples of the synthetic resins include polytetrafluoroethylene, polypropylene, and polyethylene.

The electrolytic solution contains, for example, a nonaqueous solvent and an electrolyte salt. The nonaqueous solvent includes, for example, any one of, or two or more of a cyclic carbonate ester and a chain carbonate ester. The cyclic carbonate ester is, for example, ethylene carbonate or propylene carbonate, and the chain carbonate ester is, for example, dimethyl carbonate, diethyl carbonate, or ethyl methyl carbonate.

The electrolyte salt includes, for example, any one of, or two or more of salts such as lithium salts, and the lithium salt is, for example, lithium hexafluorophosphate (LiPF₆).

Subsequently, a method of producing the battery pack 100 is described. The battery pack 100 is produced, for example, by the following procedure.

FIG. 4 illustrates a perspective configuration corresponding to FIG. 1 to explain the method of producing the battery pack 100. In this regard, FIG. 4 illustrates a state in which the battery module 20 is accommodated in the lower housing 12.

Hereinafter, a case is described in which the battery pack 100 including the six secondary batteries 40 (41 to 46) is produced with reference to FIGS. 1 to 4.

In the case of producing the battery pack 100, first, the secondary battery 40 is produced as illustrated in FIG. 3.

In the case of producing the secondary battery 40, first, a positive electrode active material layer is formed on both sides of a positive electrode current collector to produce the positive electrode 411, and a negative electrode active material layer is formed on both sides of a negative electrode current collector to produce the negative electrode 412. Subsequently, a welding method or the like is used to attach the positive electrode lead 415 to the positive electrode 411 (the positive electrode current collector), and a welding method or the like is used to attach the negative electrode lead 416 to the negative electrode 412 (the negative electrode current collector).

Subsequently, the positive electrode 411 and the negative electrode 412 are stacked with the separator 413 interposed therebetween, and the wound electrode body 410 is produced by winding the positive electrode 411, the negative electrode 412, and the separator 413. Then, the center pin 414 is inserted into a space provided at the center of the winding of the wound electrode body 410.

Subsequently, while the wound electrode body 410 is sandwiched between the pair of insulating plates 402 and 403, the pair of insulating plates 402 and 403 and the wound electrode body 410 are housed inside the battery can 401. In this case, an end of the positive electrode lead 415 is attached to the safety valve mechanism 405 by using a welding method or the like, and an end of the negative electrode lead 416 is attached to the battery can 401 by using a welding method or the like. Subsequently, an electrolytic solution is injected into the battery can 401, thereby impregnating the wound electrode body 410 with the electrolytic solution.

Finally, the battery cover 404, the safety valve mechanism 405, and the PTC element 406 are crimped to the opening end of the battery can 401 using the gasket 407. Thus, the secondary battery 40 is completed.

Subsequently, as illustrated in FIG. 2, the battery module 20 is produced by using the secondary batteries 41 to 46.

In the case of producing the battery module 20, first, the secondary batteries 41 to 46 are disposed in the six arrangement spaces 70S provided in the partition plate 70. In this case, as described above, the positive electrode terminal part 40P of each of the secondary batteries 41, 42, 45, and 46 is caused to face forward, and the negative electrode terminal part 40M of each of the secondary batteries 43 and 44 is caused to face forward. The secondary batteries 41 to 46 are thereby supported on the partition plate 70.

Subsequently, in a state where the secondary batteries 41 to 46 are supported on the partition plate 70, the individual front parts 40F of the secondary batteries 41 to 46 are inserted into the six recesses 51U provided in the front battery holder 51, and the individual rear parts 40R of the secondary batteries 41 to 46 are inserted into the six recesses 52U provided in the rear battery holder 52. This allows the secondary batteries 41 to 46 to be held in the front battery holder 51 and the rear battery holder 52 in a case where the secondary batteries 41 to 46 are supported on the partition plate 70.

Finally, the front connection terminal plate 61 (the terminal plates 611 and 612) is attached to the front battery holder 51, and the rear connection terminal plate 62 (621 and 622) is attached to the rear battery holder 52. In this case, as described above, the individual positive electrode terminal parts 40P of the secondary batteries 41, 42, 45, and 46 are caused to be electrically connected to the terminal plates 611 and 612 through the cavities 51K, and the individual negative electrode terminal parts 40M of the secondary batteries 43 and 43 are caused to be electrically connected to the terminal plate 612 through the cavities 51K. Further, as described above, the individual negative electrode terminal parts 40M of the secondary batteries 45 and 46 are caused to be connected to the terminal plate 621 through the cavities 52K, and the individual negative electrode terminal parts 40M of the secondary batteries 41 and 42 and the individual positive electrode terminal parts 40P of the secondary batteries 43 and 44 are caused to be connected to the terminal plate 622 through the cavities 52K.

Thereby, the secondary batteries 41 to 46 are connected to one another in the form of two in parallel and three in series in a state where the secondary batteries 41 to 46 are held in the front battery holder 51 and the rear battery holder 52, resulting in the completion of the battery module 20.

Finally, as illustrated in FIGS. 1 and 4, the battery pack 100 is produced by using the battery module 20.

In the case of producing the battery pack 100, first, the battery module 20 is housed inside the lower housing 12. In this case, the battery module 20 is disposed between the two protrusion portions 12T as described above.

Subsequently, the screw 13 is inserted into the screw hole 12H provided in the protrusion portion 12T through the through-hole 70H provided in the partition plate 70 of the battery module 20. This allows the partition plate 70 to be connected to the lower housing 12 and allows the battery module 20 to be fixed to the lower housing 12.

Subsequently, the circuit board 30 is disposed above the battery module 20, which allows the front connection terminal plate 61 (the terminal plate 611) to be connected to the circuit board 30 and allows the rear connection terminal plate 62 (the terminal plate 621) to be connected to the circuit board 30.

Finally, the upper housing 11 is attached to the lower housing 12, so that the battery module 20 and the circuit board 30 are enclosed in the housing 10 (the upper housing 11 and the lower housing 12). This allows the battery module 20 and the circuit board 30 to be housed in the housing 10, leading to the completion of the battery pack 100.

Subsequently, the operation of the battery pack 100 is described. Hereinafter, charge/discharge operation of the battery pack 100 is described, and then, safe operation of the battery pack 100 is described.

FIG. 5 illustrates the configuration of the cross-section of the battery pack 100 to explain safe operation of the battery pack 100. In this regard, FIG. 5 illustrates a cross-section of the battery pack 100 taken along the XZ-plane. FIG. 5 illustrates a case where, for example, the secondary battery 45 of the secondary batteries 41 to 46 generates heat excessively due to a short circuit.

When the battery pack 100 is used, for example, a charge/discharge reaction progresses in the plurality of secondary batteries 40 as described below. To be specific, during charging, lithium ions are released from the positive electrode 411, and the lithium ions are occluded in the negative electrode 412 through the electrolytic solution. On the other hand, during discharging, lithium ions are released from the negative electrode 412, and the lithium ions are occluded in the positive electrode 411 through the electrolytic solution.

When the battery pack 100 is used and the secondary battery 45 generates heat, the heat is carried to the other secondary batteries 41 to 44, and 46 through the partition plate 70 as described above. Thereby, since the heat generated in the secondary battery 45 is dispersed in the other secondary batteries 41 to 44, and 46, the heat is less likely to be stored in the secondary battery 45, which prevents variation in temperature of the individual secondary batteries 40.

In the case where the partition plate 70 contains a thermally conductive material, the heat generated in the secondary battery 45 is easy to be carried to the secondary batteries 41 to 44, and 46 through the partition plate 70, which causes the heat to be less likely to be stored in the secondary battery 45.

Further, in the case where the housing 10 contains a thermally conductive material, the heat generated in the secondary battery 45 is carried to the housing 10 through the partition plate 70 because of the connection of the partition plate 70 to the housing 10, which causes the heat to be further less likely to be stored in the secondary battery 45.

In the case where the secondary battery 45 generates heat excessively due to a short circuit, or the like, the front battery holder 51 expands thermally in the vicinity of the secondary battery 45 because the front battery holder 51 contains a thermal expansion material.

Thereby, as shown in FIG. 5, stresses F1 to F3 are applied to the abnormal secondary battery 45 that is the heat source and the normal secondary batteries 43 and 46 in the vicinity thereof by primarily using the thermal expansion phenomenon of the front battery holder 51, the secondary batteries 43, 45, and 46 are displaced.

Specifically, in a state where the secondary batteries 43, 45, and 46 are held in one front battery holder 51 having a thermal expansion property, the front battery holder 51 expands thermally in the vicinity of the secondary battery 45. This allows the stresses F1 to F3 with different directions to be applied to the secondary batteries 43, 45, and 46, which causes the secondary batteries 43, 45, and 46 to be displaced in directions different from one another.

Specifically, since the stress F1 in the upper left diagonal direction is applied to the abnormal secondary battery 45 that is the heat source, the secondary battery 45 is displaced in the upper left diagonal direction. In contrast, since the stress F2 in the upper right diagonal direction is applied to the normal secondary battery 43, the secondary battery 43 is displaced in the upper right diagonal direction, and since the stress F3 in the lower left diagonal direction is applied to the normal secondary battery 46, the secondary battery 46 is displaced in the lower left diagonal direction.

Thus, the abnormal secondary battery 45 that is the heat source is displaced away from each of the normal secondary batteries 43 and 46, and the normal secondary batteries 43 and 46 are displaced away from the abnormal secondary battery 45. This isolates the secondary battery 45 from the secondary batteries 43 and 46 even if the secondary battery 45 generates heat excessively, which causes the heat generated in the secondary battery 45 to be hardly carried to the secondary batteries 43 and 46.

In this case, when the secondary battery 45 is displaced by using the thermal expansion phenomenon of the front battery holder 51, the secondary battery 45 withdraws from the arrangement space 70S. This causes the secondary battery 45 to be spaced apart from the partition plate 70, and the heat generated in the secondary battery 45 is less likely to be carried to the secondary batteries 43 and 46 through the partition plate 70. This causes the heat generated in the secondary battery 45 to be hardly carried to the secondary batteries 43 and 46 even if the partition plate 70 contains a thermally conductive material.

An advantage of using the thermal expansion phenomenon of the front battery holder 51 is obtained also in the rear battery holder 52 which similarly contains a thermal expansion material. To be specific, when the secondary battery 45 generates heat, the rear battery holder 52 expands thermally so that the stresses F1 to F3 are applied to the secondary batteries 43, 45, and 46, and therefore, the secondary batteries 43, 45, and 46 are so displaced away from one another.

Subsequently, an action and effect of the battery pack 100 are described.

According to the battery pack 100, the battery holder 50 for holding the plurality of secondary batteries 40 is included. The battery holder 50 includes the partition parts 511 and 512 for defining an arrangement area where the plurality of secondary batteries 40 is disposed, and the battery holder 50 (the partition parts 511 and 512) contains a thermal expansion material. In this case, as described above, when a part of the plurality of secondary batteries 40 generates heat, the abnormal secondary battery 40 that is the heat source is so displaced away from the other normal secondary batteries 40 by using the thermal expansion phenomenon of the battery holder 50. This causes the heat generated in the abnormal secondary battery 40 to be hardly carried to the other normal secondary batteries 40, which prevents the normal secondary batteries 40 from being heated. This causes the entirety of the battery module 20 to be less likely to store the heat therein, and the plurality of secondary batteries 40 is less likely to catch fire. This therefore improves the safety.

In particular, in the case where the battery holder 50 contains a thermal expansion material, as described above, the battery holder 50 thermally expands only when a part of the secondary batteries 40 generates heat excessively. Thereby, in the case where an amount of heat generated in the part of the secondary batteries 40 is small, the plurality of secondary batteries 40 is intentionally kept close to one another; thereby the heat generated in the part of the secondary batteries 40 is dispersed in the plurality of secondary batteries 40, which prevents variation in temperature of the individual secondary batteries 40. Thus, at the use of the ordinary battery pack 100, the plurality of secondary batteries 40 can be charged and discharged with a large current.

On the other hand, in the case where a part of the secondary batteries 40 generates heat excessively due to a short circuit and so on, and the amount of heat generated in the part of the secondary batteries 40 is large, the part of the secondary batteries 40 that is the abnormal battery and the heat source is intentionally made away from the other normal secondary batteries 40 by using the thermal expansion phenomenon of the battery holder 50; therefore the plurality of secondary batteries 40 is less likely to catch fire. Thus, the safety is secured when an abnormal situation such as a short circuit occurs.

Further, in the case where a part of the secondary batteries 40 generates heat excessively, as described above, the battery holder 50 expands thermally in response to the heat generation. Therefore, after the part of the secondary batteries 40 generates heat excessively, a distance between the plurality of secondary batteries 40 is automatically increased. Thereby, before the part of the secondary batteries 40 generates heat excessively, as described above, in order that the distance between the plurality of secondary batteries 40 can be shortened so that, in the case of a small amount of heat generation, the heat generated in the part of the secondary batteries 40 is dispersed in the other secondary batteries 40. Thus, it is unnecessary to keep the distance between the plurality of secondary batteries 40 large before the part of the secondary batteries 40 generates heat excessively. It is therefore possible to reduce the size of the battery module 20 and the battery pack 100.

Further, since the battery holder 50 itself for holding the plurality of secondary batteries 40 has a thermal expansion property, it is unnecessary to separately provide a thermal expansion member between the plurality of secondary batteries 40 in order to increase a distance between the plurality of secondary batteries 40 when the part of the secondary batteries 40 generates heat excessively. In terms of the elimination of the thermal expansion member, each of the battery module 20 and the battery pack 100 can be downsized.

Besides, in the case where the battery holder 50 includes the frame parts 512 and 522 along with the partition parts 511 and 521, the plurality of secondary batteries 40 is held stably in the battery holder 50 in a state where the plurality of secondary batteries 40 is spaced apart from one another with an interval. Thus, catching fire is less likely to occur with the plurality of secondary batteries 40 spaced and held stably, which provides a higher effect.

In the case where the thermal expansion material includes thermal expansion rubber, more specifically, in the case where the thermal expansion material has a thermal expansion ratio of 5 times or more, the battery holder 50 sufficiently expands thermally at the time of heat generation of the secondary battery 40, which provides a higher effect.

In the case where the connection terminal plate 60 (the front connection terminal plate 61 and the rear connection terminal plate 62) stretchable in accordance with displacement of the plurality of secondary batteries 40 is electrically connected to the plurality of secondary batteries 40, the electrical connection between the plurality of secondary batteries 40 and the connection terminal plate 60 is easy to be maintained even if the plurality of secondary batteries 40 is displaced using the thermal expansion phenomenon of the battery holder 50. Thus, catching fire is less likely to occur with the function of the battery module 20 which is a battery element secured, which provides a higher effect.

In this case, in the case where the connection terminal plate 60 has the bent portions 61B and 62B, the connection terminal plate 60 easily stretches stably by using the bent portions 61B and 62B, which provides a further high effect.

In the case where the battery holder 50 includes the front battery holder 51 for holding the front part 40F of the secondary battery 40 and the rear battery holder 52 for holding the rear part 40 of the secondary battery 40, the plurality of secondary batteries 40 is easy to be held stably in the battery holder 50. Thus, the plurality of secondary batteries 40 is easy to be displaced stably by using the thermal expansion phenomenon of the battery holder 50, which provides a higher effect.

In this case, the plurality of secondary batteries 70 is easy to be disposed with the plurality of secondary batteries 70 spaced apart from one another, provided that the partition plate 70 is provided between the front battery holder 51 and the rear battery holder 52. Thus, the plurality of secondary batteries 40 is easy to be displaced stably by using the thermal expansion phenomenon of the battery holder 50, which provides a higher effect.

In the case where the partition plate 70 contains a thermal expansion material, the plurality of secondary batteries 40 is displaced by using not only the thermal expansion phenomenon of the battery holder 50 but also the thermal expansion phenomenon of the partition plate 70, which allows the plurality of secondary batteries 40 to be displaced easily. Thus, the plurality of secondary batteries 40 is less likely to catch fire, which provides a higher effect.

Further, in the case where the partition plate 70 contains a thermal expansion material, even if the plurality of secondary batteries 40 generates heat, the heat is easily carried from the plurality of secondary batteries 40 to the partition plate 70. Thus, the heat is less likely to be stored in the plurality of secondary batteries 40, which provides a higher effect.

In the case where the plurality of secondary batteries 40 and the battery holder 50 are housed in the housing 10 and the partition plate 70 is connected to the housing 10, a gap between the housing 10 and the plurality of secondary batteries 40 held in the battery holder 50 is easy to be kept. Thus, the plurality of secondary batteries 40 is easy to be displaced stably by using the thermal expansion phenomenon of the battery holder 50, which provides a higher effect.

In this case, the heat generated in the secondary battery 40 is easy to be carried to the housing 10 through the partition plate 70, provided that each of the housing 10 and the partition plate 70 contains a thermally conductive material. Thus, the heat is less likely to be stored in the battery module 20, which provides a higher effect.

Subsequently, the description goes on to a modification to the battery pack 100. The configuration of the battery pack 100 can be changed as appropriate.

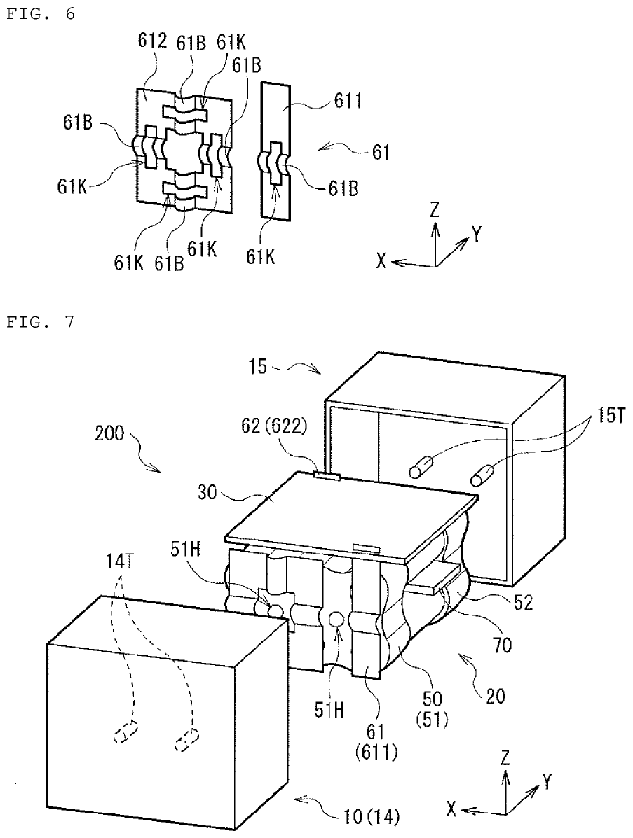

For example, as illustrated in FIG. 6 corresponding to FIG. 2, an opening 61K may be provided in an area where at least a bent portion 60B of the front connection terminal plate 61 is provided. The opening 61K is, for example, a so-called slit. Note that the opening 61K may be provided only in the bent portion 61B, or the opening 61K may extend from the bent portion 61B to the peripheral area.

The number of openings 61K is not particularly limited, and may be only one or two or more.

Specifically, in the terminal plate 611, for example, the openings 61K are provided in the bent portion 61B and the vicinity area thereof so as to extend in the height direction. In other words, the terminal plate 611 is provided with, for example, one opening 61K. In this example, the opening 61K extends to, for example, an upper area of the bent portion 61B and to a lower area of the bent portion 61B.

In the terminal plate 612, for example, the openings 61K are provided in the bent portion 61B and the vicinity area thereof so as to extend in the height direction, and the openings 61K are provided in the bent portion 61B and the vicinity area thereof so as to extend in the width direction. Specifically, the terminal plate 612 is provided with, for example, the four openings 61K. In this example, the opening 61K extends to, for example, an upper area of the bent portion 61B and to a lower area of the bent portion 61B. Further, the opening 61K extends to, for example, a left area of the bent portion 61B and to a right area of the bent portion 61B.

In the case where the opening 61K is provided in the front connection terminal plate 61, the width of the front connection terminal plate 61 (the bent portion 61B) in the area where the corresponding opening 61K is provided is small. In this case, the front connection terminal plate 61 is more deformable, which allows the front connection terminal plate 61 to easily stretch. Thus, even when the plurality of secondary batteries 40 is displaced, the electrical connection between the plurality of secondary batteries 40 and the front connection terminal plate 61 is kept more easily, which provides a higher effect.

The description takes an example in which the first modification is applied to the front connection terminal plate 61; however, the first modification may be applied to the rear connection terminal plate 62. In this case, the rear connection terminal plate 62 is more deformable, which allows the rear connection terminal plate 62 to easily stretch. Thus, even when the plurality of secondary batteries 40 is displaced, the electrical connection between the plurality of secondary batteries 40 and the rear connection terminal plate 62 is kept more easily, which provides a similar effect.

While both the front battery holder 51 and the rear battery holder 52 contain a thermal expansion material, it is possible that any one of the front battery holder 51 and the rear battery holder 52 contains a thermal expansion material. Also, in this case, as compared with a case where none of the front battery holder 51 and the rear battery holder 52 contains a thermal expansion material, the plurality of secondary batteries 40 is easy to be displaced by using the thermal expansion phenomenon of the battery holder 50, which provides a similar effect.

It should be understood that, however, both the front battery holder 51 and the rear battery holder 52 preferably contain a thermal expansion material in order to cause the plurality of secondary batteries 40 to deform more easily.

While only one of the two protrusion portions 12T is provided with the screw hole 12H, it is possible that both of the two protrusion portions 12T are provided with the screw hole 12H. In this case, since the battery module 20 is fixed to the lower housing 12 (2-point fixing) with two screws 13, the fixing strength of the battery module 20 to the lower housing 12 is improved as compared with a case where the battery module 20 is fixed to the lower housing 12 (1-point fixing) with one screw 13. This reduces the positional shift of the battery module 20 due to vibration inside the housing 10 or the like, so that a gap between the housing 10 and the plurality of secondary batteries 40 held in the battery holder 50 is easy to be kept. This allows the plurality of secondary batteries 40 to be displaced more stably, which provides a higher effect.

The partition plate 70 is provided with the two through-holes 70H; however, the partition plate 70 may be provided with one through-hole 70H. Also, in this case, the battery module 20 is fixed to the lower housing 112 with the screw 13, which provides a similar effect.

Subsequently, a battery pack according to a second embodiment of the present technology is described.

As described below, a battery pack 200 that is an example of a battery pack according to the present embodiment has a configuration similar to that of the battery pack 100 according to the first embodiment, except that the configuration of each of the housing 10, the battery holder 50 (the front battery holder 51 and the rear battery holder 52), and the partition plate 70 is different from that of the first embodiment. Hereinafter, the elements of the battery pack 100 are referred to as needed.

FIG. 7 illustrates a perspective configuration of the battery pack 200 and corresponds to FIG. 1. FIG. 8 illustrates a perspective configuration of the battery holder 50 (the front battery holder 51 and the rear battery holder 52) illustrated in FIG. 7 and corresponds to FIG. 2.

As illustrated in FIG. 7, for example, the housing 10 includes a front housing 14 and a rear housing 15 instead of the upper housing 11 and the lower housing 12.

The front housing 14 has, on an inner wall surface thereof, a protrusion portion 14T extending in the length direction, for example. Further, the rear housing 15 has, on an inner wall surface thereof, a protrusion portion 15T extending in the length direction. The number of each of the protrusion portions 14T and 15T is not particularly limited. In this case, the number of each of the protrusion portions 14T and 15T is 2, for example.

As illustrated in FIG. 8, for example, the front battery holder 51 has a through-hole 51H extending in the length direction at a position corresponding to the protrusion portion 14T described above. Further, as illustrated in FIG. 8, for example, the rear battery holder 52 has a through-hole 52H extending in the length direction at a position corresponding to the protrusion portion 15T described above. The number of each of the through-holes 51H and 52H is not particularly limited.

In this case, the number of each of the through-holes 51H and 52H is 2, for example, corresponding to the number of each of the protrusion portions 14T and 15T.

In the battery pack 200, for example, in the case where the front housing 14 and the rear housing 15 are combined together to accommodate the battery module 20 in the housing 10 (the front housing 14 and the rear housing 15), the protrusion portion 14T and the protrusion portion 15T are inserted into the through-hole 51H and the through-hole 52H, respectively. Thereby, the battery module 20 is aligned with the housing 10 and is fixed thereto.

In this case, the battery module 20 is fixed to the housing 10 by using the protrusion portions 14T and 15T and the through-holes 51H and 52H; therefore, for example, the housing 10 is not necessarily provided with the protrusion portion 12T, and the partition plate 70 is not necessarily provided with the through-hole 70H.

The battery pack 200 is produced by procedures similar to those of the production method of the battery pack 100, for example, except that the front housing 14 and the rear housing 15 are used instead of the upper housing 11 and the lower housing 12, and that the protrusion portions 14T and 15T are inserted into the through-holes 51H and 52H respectively when the battery module 20 is housed in the housing 10.

The battery pack 200 operates (performs charge/discharge operation and safe operation) as with the battery pack 100 except that the partition plate 70 is not connected to the housing 10; therefore, even if the housing 10 contains a thermally conductive material, heat generated in the secondary battery 40 is not carried to the housing 10 through the partition plate 70.

According to the battery pack 200, the battery holder 50 for holding the plurality of secondary batteries 40 contains a thermal expansion material, which improves the safety because of the same reason of the battery pack 100. Another action and effect regarding the battery pack 200 other than this is similar to the action and effect regarding the battery pack 100.

The configuration of the battery pack 200 can be changed as appropriate.

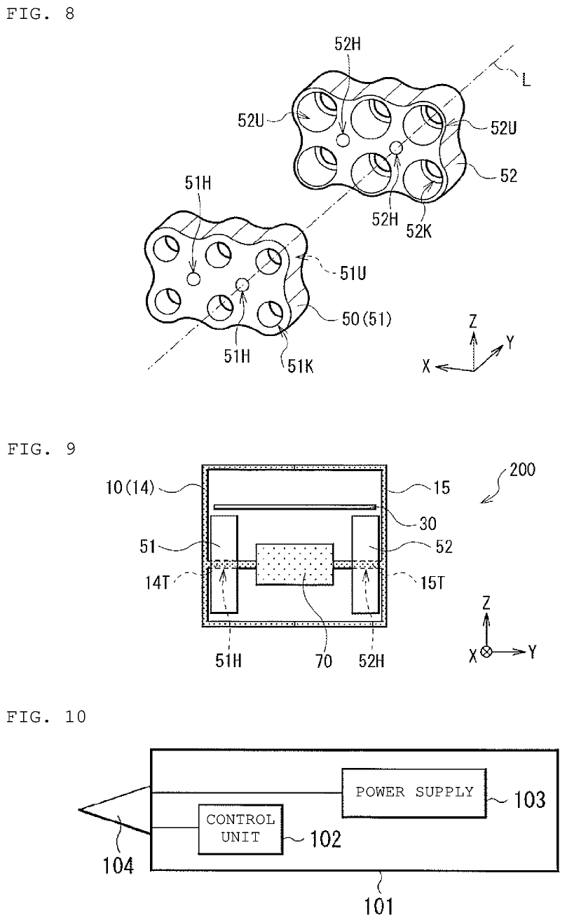

FIG. 9 illustrates a modification regarding the configuration of the battery pack 200, and illustrates the configuration of the cross-section of the battery pack 200 taken along the YZ-plane. Note that, in FIG. 9, each of the housing 10 and the partition plate 70 is shaded for easy understanding of the connection relationship between the housing 10 and the partition plate 70. Further, in FIG. 9, the plurality of secondary batteries 40 and the connection terminal plate 60 (the front connection terminal plate 61 and the rear connection terminal plate 62) are not illustrated.

In the case where the front housing 14 and the rear housing 15 are used as the housing 10, for example, as illustrated in FIG. 9, each of the protrusion portions 14T and 15T may be extended to allow each of the protrusion portions 14T and 15T to abut on the partition plate 70. This allows the protrusion portion 14T to contact the partition plate 70 through the through-hole 51H, and the protrusion portion 15T to contact the partition plate 70 through the through-hole 52H.

In this case, the housing 10 (the front housing 14 and the rear housing 15) contains a thermally conductive material, and the partition plate 70 also contains a thermally conductive material; thereby, as with the battery pack 100, the heat generated in the secondary battery 40 is easy to be carried to the housing 10 through the partition plate 70. Thus, the heat is less likely to be stored in the secondary battery 40, which provides a higher effect.

As described above, in the case where the protrusion portion 14T contacts the partition plate 70 through the through-hole 51H, for example, the partition plate 70 may have a recess into which the protrusion portion 14T is inserted. Since the protrusion portion 14T is fixed to the partition plate 70, the electrical connection between the protrusion portion 14T and the partition plate 70 is easily maintained. Further, a contact area of the protrusion portion 14T to the partition plate 70 is large, which allows the heat generated in the secondary battery 40 to be easily carried to the housing 10 (the protrusion portion 14T) through the partition plate 70. Thereby, a further higher effect can be obtained.

The description takes an example in which the second modification is applied to the protrusion portion 14T and the partition plate 70; however, of course, the second modification may be applied to the protrusion portion 15T and the partition plate 70. In this case, the electrical connection between the protrusion portion 15T and the partition plate 70 is easy to be maintained, and the heat generated in the secondary battery 40 is easy to be carried to the housing 10 (the protrusion portion 15T) through the partition plate 70, so that a similar effect can be obtained.

Subsequently, application examples of the above-described battery pack are described.

The application of the battery pack is not particularly limited, as long as the battery pack is applied to machines, devices, instruments, apparatuses, systems, and the like (assembly of a plurality of devices or the like) that can use the battery pack as a driving power supply, a power storage source for reserve of power, and the like. The battery pack for use as a power supply may be served as a main power supply or an auxiliary power supply. The main power supply is a power supply that is used preferentially, regardless of the presence or absence of other power supplies. The auxiliary power supply may be, for example, a power supply which is used instead of the main power supply, or a power supply which is switched from the main power supply, if necessary. When the battery pack is used as an auxiliary power supply, the main power supply is not limited to the battery pack.

Here are applications of the battery pack, for example: electronic devices (including portable electronic devices) such as video cameras, digital still cameras, mobile phones, laptop personal computers, cordless telephones, headphone stereos, portable radios, portable televisions, and portable information terminals; portable life instruments such as electric shavers; storage devices such as backup power supplies and memory cards; power tools such as electric drills and electric saws; medical electronic devices such as pacemakers and hearing aids: electric vehicles such as electric cars (including hybrid cars); and power storage systems such as a domestic battery system that stores electric power in preparation for emergency or the like. Of course, the application of the battery pack may be any other application than the foregoing.

Above all, it is effective to apply the battery pack to an electric vehicle, a power storage system, a power tool, an electronic device, or the like, and it is particularly effective to apply the battery pack to a power tool. This is because, since these application require excellent battery characteristics, the use of the battery pack according to the present technology can improve the performance effectively.

It should be understood that the electric vehicle is a vehicle that operates (travels) with the battery pack as a driving power supply, and may be a vehicle (a hybrid car or the like) provided with a driving source other than the battery pack as mentioned above. The power storage system is a system using a battery pack as a power storage source. For example, for a household power storage system, electric power is stored in the battery pack which serves as a power storage source, thus making it possible to use home electric appliances and the like through the use of electric power. The power tool is a tool which makes a movable part (such as a drill) movable with the battery pack used as a driving power supply. The electronic device is a device that performs various functions with the battery pack as a driving power supply (power supply source).

In this regard, application examples of the battery pack are specifically described. The configuration of each application example described below is just considered by way of example, and the configuration of the application example can be thus changed appropriately.

FIG. 10 illustrates a block configuration of a power tool.

The power tool described herein is, for example, an electric drill. The power tool includes, for example, a control unit 102 and a power supply 103 inside a tool body 101. For example, a drill part 104 as a movable part is operably (rotatably) attached to the tool body 101.

The tool body 101 contains, for example, any one of, or two or more of metal materials and polymer materials. The control unit 102 controls the operation (including the usage state of the power supply 103) of the whole power tool. The control unit 102 includes, for example, a central processing unit (CPU). The power supply 103 includes one or two or more battery packs. The control unit 102 supplies electric power from the power supply 103 to the drill part 104 in response to operation of an operation switch.

The present technology has been described above with reference to some embodiments; however, the present technology is not limited to the aspects described in the embodiments, and various modifications may be made to the present technology.

Specifically, the case where the battery structure of the secondary battery is cylindrical has been described, for example; however, the battery structure of the secondary battery applied to the battery pack of the present technology is not particularly limited. Specifically, the battery structure of the secondary battery may be a laminate film structure, a square structure, and a coin structure.

The case where the secondary battery has the wound structure has been described; however, the structure of the secondary battery is not particularly limited. Specifically, the secondary battery may have, for example, another structure such as a laminated structure.

Although lithium is used as an electrode reactant of the secondary battery, the type of the electrode reactant is not particularly limited. Specifically, the electrode reactant may be, for example, another element of Group 1 in the long-periodic table (such as sodium or potassium), an element of Group 2 in the long-periodic table (such as magnesium or calcium) or another light metal (such as aluminum).

In addition, the effects described in the present specification are not limiting but are merely examples, and there may be additional effects.

Additionally, the present technology is further described below in detail according to an embodiment.

(1)

A battery pack including:

a plurality of secondary batteries; and

a battery holding member that: (A) holds the plurality of secondary batteries; (B) includes a partition part provided between the plurality of secondary batteries to define an arrangement area where the plurality of secondary batteries is disposed; and (C) includes a thermal expansion material.

(2)

The battery pack according to (1),

in which the battery holding member further includes a frame part that is disposed around the plurality of secondary batteries and is connected to the partition part.

(3)

The battery pack according to (1) or (2),

in which the thermal expansion material includes at least one of thermal expansion rubber and thermal expansion sponge.

(4)

The battery pack according to any one of (1) to (3),

in which the thermal expansion material has a thermal expansion ratio of 5 times or more.

(5)

The battery pack according to any one of (1) to (4),

further including a connection terminal member that is electrically connected to two or more of the plurality of secondary batteries and is stretchable in response to displacement of the two or more of the plurality of secondary batteries.

(6)

The battery pack according to any one of (1) to (4),

further including a connection terminal member that is electrically connected to two or more of the plurality of secondary batteries and includes a bent portion so bent as to be partly away from the two or more of the plurality of secondary batteries.

(7)

The battery pack according to (6),

in which the connection terminal member includes an opening in an area where at least the bent portion is provided.

(8)

The battery pack according to any one of (1) to (7), in which

each of the plurality of secondary batteries

includes

a first end, and

a second end opposite to the first end,

the battery holding member

includes

a first battery holding member for holding the first end, and

a secondary battery holding member for holding the second end.

(9)

The battery pack according to (8),

further including, between the first battery holding member and the secondary battery holding member, a partition member that is disposed between the plurality of secondary batteries to define an arrangement area where the plurality of secondary batteries is disposed.

(10)

The battery pack according to (9),

in which the partition member includes a thermal expansion material.

(11)

The battery pack according to (9),

further including a housing member that accommodates the plurality of secondary batteries and the battery holding member,

in which the partition member is connected to the housing member.

(12)

The battery pack according to (11),

in which each of the partition member and the housing member includes a thermally conductive material.

(13)

The battery pack according to any one of (1) to (12),

further including a housing member that accommodates the plurality of secondary batteries and the battery holding member, and has an interval between each of the plurality of secondary batteries held in the battery holding member.

(14)

The battery pack according to any one of (1) to (13),

in which each of the plurality of secondary batteries is a lithium ion secondary battery.

(15)

A power tool including:

a battery pack according to any one of (1) to (14); and

a movable part supplied with electric power from the battery pack.

(16)

An electronic device according to any one of (1) to (14) including a battery pack as a power supply source.

It should be understood that various changes and modifications to the presently preferred embodiments described herein will be apparent to those skilled in the art. Such changes and modifications can be made without departing from the spirit and scope of the present subject matter and without diminishing its intended advantages. It is therefore intended that such changes and modifications be covered by the appended claims.

1. A battery pack comprising:
a plurality of secondary batteries; and
a battery holding member configured to hold the plurality of secondary batteries,
wherein the battery holding member includes a partition part and a thermal expansion material, and
wherein the partition part is provided between the plurality of secondary batteries to define an arrangement area where the plurality of secondary batteries is disposed.

2. The battery pack according to claim 1,
wherein the battery holding member further includes a frame part, and wherein the frame part is disposed around the plurality of secondary batteries and is connected to the partition part.

3. The battery pack according to claim 1,
wherein the thermal expansion material includes at least one of thermal expansion rubber and thermal expansion sponge.

4. The battery pack according to claim 1,
wherein the thermal expansion material has a thermal expansion ratio of 5 times or more.

5. The battery pack according to claim 1,
further comprising a connection terminal member, wherein the connection terminal member is electrically connected to two or more of the plurality of secondary batteries and is stretchable in response to displacement of the two or more of the plurality of secondary batteries.

6. The battery pack according to claim 1, further comprising a connection terminal member, wherein the connection terminal member is electrically connected to two or more of the plurality of secondary batteries and includes a bent portion so bent as to be partly away from the two or more of the plurality of secondary batteries.

7. The battery pack according to claim 6,
wherein the connection terminal member includes an opening in an area where at least the bent portion is provided.

8. The battery pack according to claim 1, wherein
each of the plurality of secondary batteries
includes
a first end, and
a second end opposite to the first end,
the battery holding member
includes
a first battery holding member configured to hold the first end, and
a secondary battery holding member configured to hold the second end.

9. The battery pack according to claim 8,
further comprising a partition member between the first battery holding member and the secondary battery holding member, wherein the partition member is disposed between the plurality of secondary batteries to define an arrangement area where the plurality of secondary batteries is disposed.

10. The battery pack according to claim 9,
wherein the partition member includes a thermal expansion material.

11. The battery pack according to claim 9,
further comprising a housing member configured to accommodate the plurality of secondary batteries and the battery holding member, wherein
the partition member is connected to the housing member.

12. The battery pack according to claim 11,
wherein each of the partition member and the housing member includes a thermally conductive material.

13. The battery pack according to claim 1,
further comprising a housing member configured to accommodate the plurality of secondary batteries and the battery holding member, wherein the housing member has an interval between each of the plurality of secondary batteries held in the battery holding member.

14. The battery pack according to claim 1,
wherein the plurality of secondary batteries include at least a lithium ion secondary battery.

15. A power tool comprising:
a battery pack; and
a movable part configured to be supplied with electric power from the battery pack, wherein
the battery pack includes
a plurality of secondary batteries, and
a battery holding member configured to hold the plurality of secondary batteries,
wherein the battery holding member includes a partition part and a thermal expansion material, and
wherein the partition part is provided between the plurality of secondary batteries to define an arrangement area where the plurality of secondary batteries is disposed.

16. An electronic device comprising a battery pack as a power supply source, wherein
the battery pack includes
a plurality of secondary batteries, and
a battery holding member configured to hold the plurality of secondary batteries,
wherein the battery holding member includes a partition part and a thermal expansion material, and
wherein the partition part is provided between the plurality of secondary batteries to define an arrangement area where the plurality of secondary batteries is disposed.
